(19) United States
(12) Patent Application Publication
(10) Pub. No.: US 2025/0370089 A1
(43) Pub. Date: Dec. 4, 2025

(54) HIGH RESOLUTION DIGITAL IMAGING SYSTEM

(71) Applicant: The Board of Trustees of the Leland Stanford Junior University, Stanford, CA (US)

(72) Inventors: Thomas H. Lee, Burlingame, CA (US); Yinuo Xu, Sunnyvale, CA (US)

(21) Appl. No.: 19/225,858

(22) Filed: Jun. 2, 2025

Related U.S. Application Data
(60) Provisional application No. 63/655,478, filed on Jun. 3, 2024.

(51) Int. Cl. G01S 7/03; G01S 13/89

(52) U.S. Cl. CPC G01S 7/03; G01S 13/89

(57) ABSTRACT

A system includes a transmitter, a receiver, and a processor. The transmitter includes a digital encoder configured to receive a carrier signal between 100 GHz and 3 THz, wherein the digital encoder is further configured to receive a digital code and to modulate the digital code with the carrier signal to form an encoded digital signal. The transmitter includes a transmitting antenna configured to receive the encoded digital signal and transmit the encoded digital signal out. The receiver includes a receiving antenna configured to receive an echoed signal in response to the encoded digital signal interacting with an object. The receiver includes a digital decoder configured to decode the echoed signal based on the digital code to form a decoded echoed signal. The processor is configured to receive the decoded echoed signal and further configured to process the decoded echoed signal to determine spatial information with respect to the object.

### RELATED APPLICATIONS

The instant application claims the benefit and priority to the provisional patent application No. 63/655,478 filed on Jun. 3, 2024, which is incorporated herein by reference in its entirety.

### BACKGROUND

Object detection has become an integral part of self-driving vehicles. For example, a self-driving vehicle should be able to distinguish between another vehicle that is parked or in motion, between a person and an animal, and recognize various objects. These capabilities are essential to ensure appropriate and safe vehicular behavior.

Some conventional detection system systems use complex cameras, and/or light detection and ranging (LiDAR) with short wavelengths for extracting spatial information. Use of short wavelengths means that the device is highly sensitive to small environmental variations and therefore often perform very poorly when conditions change, e.g., in bad weather.

A radio-frequency sensor, such as radar, can overcome environmental limitations by operating at longer wavelengths. Typically, radar is capable for object detection, distinguishing between different entities like people and vehicles, and obtaining their spatial information (e.g., positions and movement trajectories). This is done by analyzing the frequency and phase content of the echoed signal. However, this extraction methodology places a significant burden on the analog and frontend circuitries, which are demanding in terms of area and power and generally require specialized processes, making low-cost large-scale deployment of radar systems challenging.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of a hardware-based system for deriving spatial information according to one aspect of the present embodiments.

FIG. 2 depicts another example of a diagram of a hardware-based system for deriving spatial information according to one aspect of the present embodiments.

FIG. 3 depicts yet another example of a diagram of a hardware-based system for deriving spatial information according to one aspect of the present embodiments.

FIG. 4 depicts an example of a diagram of a transmitter according to one aspect of the present embodiments.

FIGS. 5A-5E depict a system for performing digital encoding according to one aspect of the present embodiments.

FIG. 6 depicts an example of a diagram of a receiver according to one aspect of the present embodiments.

FIGS. 7A-7E depict examples of a lens used on a transmitter and/or receiver according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing certain concepts, and the terminology is not intended to be limiting. Unless defined otherwise, all technical and scientific terms used herein have the same meaning as commonly understood in the art to which the embodiments pertain.

A need has arisen to design an object detection system that can scale at low cost with high accuracy and little to no degradation in performance when the condition changes, e.g., poor weather conditions. The embodiments provide high resolution surround mapping solution where the performance is resistance to change in weather conditions in comparison to conventional systems such as LiDAR solution. The embodiments are substantially less costly by leveraging complementary metal-oxide-semiconductor (CMOS) technology and are highly scalable due to its unique interference rejection mechanism.

The embodiments digitally encode a carrier signal between 100 GHz and 3 THz that is transmitted. The transmitted signal is reflected from an object, e.g., a vehicle, a bicycle, a person, etc., or a plurality of objects, and the reflected signal is detected by a receiver. The receiver performs digital decoding of the received signal and derives spatial information, e.g., position, velocity, angle, distance, geometrical shapes and dimensions, etc., from the received signal.

It is appreciated that the examples are described with respect to automotive applications for illustrative purposes and should not be construed as limiting the scope of the embodiments. For example, the embodiments are equally applicable to not only automotive applications (sensors) but also to indoor/outdoor motion detection, security scanning devices, airplanes, etc.

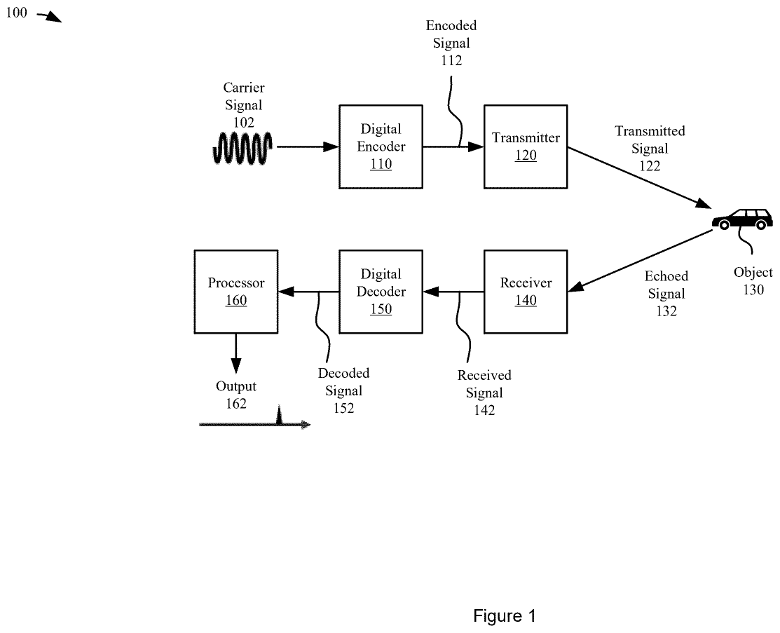

FIG. 1 depicts an example of a diagram of a hardware-based system 100 for deriving spatial information according to one aspect of the present embodiments. In one nonlimiting example, a carrier signal 102 that is close to or near THz is generated and sent to a digital encoder 110. The digital encoder 110 encodes the carrier signal 102 with a unique code, forming encoded signal 112. As such, the carrier signal 102 becomes distinguishable from other signals and to further reduce interference among different signals. The digital code used by the digital encoder 110 to encode the carrier signal 102 may be deterministic, random, or pseudorandom sequence. It is appreciated that the bandwidth per code determines the range resolution. The bandwidth may be dynamically adjusted, as desired.

The encoded signal 112 is sent to a transmitter 120, e.g., an antenna, which is transmitted out, as transmitted signal 122. The transmitted signal 122 may reach an object 130 (e.g., contact or interact with the object 130). According to one nonlimiting example, the transmitted signal may be echoed (resulting from interaction with the object 130), as echoed signal 132, that is subsequently received by a receiver 140, e.g., an antenna. The received signal 142 is digitally decoded by the digital decoder 150 to form a decoded signal 152. The decoded signal 152 may be sent to a processor 160, a processing unit (PU), for processing. The processor 160 outputs an output 162 signal that is spatial information associated with the object 130, e.g., distance of the transmitter 120 to the object 130, velocity of the object 130, angle associated with the object 130, position of the object 130, geometrical shapes and dimensions of the object 130, etc. In other words, the system 100 operates substantially in a digital domain and extracts spatial information fully in the digital domain with minimum requirement in analog/RF circuit. The system 100 in one nonlimiting example is configured to detect the presence of a target, e.g., object 130, and determines spatial information, e.g., speed, acceleration, direction, position, distance, angle, geometrical shapes and dimensions of the object 130, etc., associated with the target using the reflection or reradiation of radio waves that operate in the frequency range from 100 GHz to 3 THz in the digital domain. As such, system 100 may be constructed using CMOS processes, which are low power, cost-effective, and highly scalable.

It is appreciated that the repetition frequency (frame rate and sub-frame rate) may be dynamically adjusted to reduce interference and to increase signal-to-noise ratio (SNR). Moreover, it is appreciated that the modulated signal may be dynamically tuned to mitigate interference (e.g., nearby interference). Furthermore, it is appreciated that the transmitter side and the receiver side, may have array elements that operate with separate code sequences. It is appreciated that the examples are described with respect to the transmitter and receiver being in different physical locations for illustrative purposes that should not be construed as limiting the scope. For example, in some embodiments, the transmitter and the receiver may be mounted in the same physical location. It is also appreciated that the echoed signal is shown as a reflection off of the object 130 for illustrative purposes and should not be construed as limiting the scope of the embodiments. For example, the transmitted signal 122 may interact with other objects, e.g., trees, other structures, etc., and combine with the reflection off of the object 130 to form the echoed signal 132.

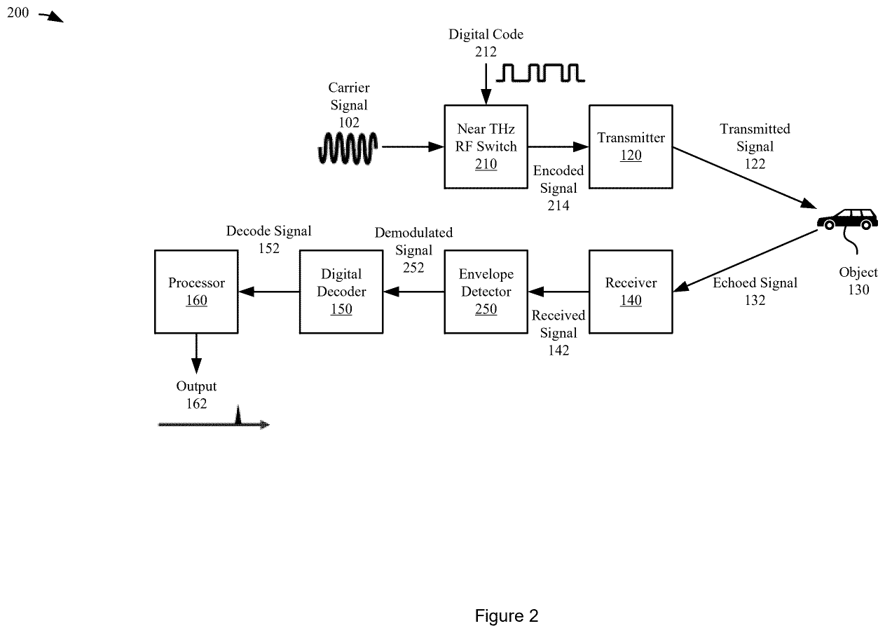

FIG. 2 depicts another example of a diagram of a hardware-based system 200 for deriving spatial information according to one aspect of the present embodiments. System 200 is similar to system 100 of FIG. 1, except that the digital encoder 110 of system 100 is replaced with near THz RF switch 210 that is configured to receive a digital code 212. The near THz RF switch 210 encodes the carrier signal 102 with the digital code 212 to form an encoded signal 214 and sends the encoded signal 214 to the transmitter 120 for transmission. On the receiver side, receiver 140 receives the echoed signal 132 as the received signal 142 and sends the received signal 142 to an envelope detector 250 unit. The envelope detector 250 unit is configured to receive the received signal 142 (e.g., amplitude modulated signal) from the receiver 140 and demodulates it to generate the demodulated envelope of the original signal to form a demodulated signal 252. The demodulated signal 252 is subsequent sent to the digital decoder 150. The remainder of the operation is similar to that of FIG. 1, as described above.

It is appreciated that the embodiments are configured to detect the presence of a target or a plurality of targets, and determine the distance to the target. In one nonlimiting example, angular information may be available when the transmitter and the receiver are mounted on a scanning or rotational apparatus. In one nonlimiting example, the distance that the transmitter and the receiver travel may be used to determine the sensor angular resolution. In some examples, the velocity of the object may be determined by tracking the change in distance between measurement instances.

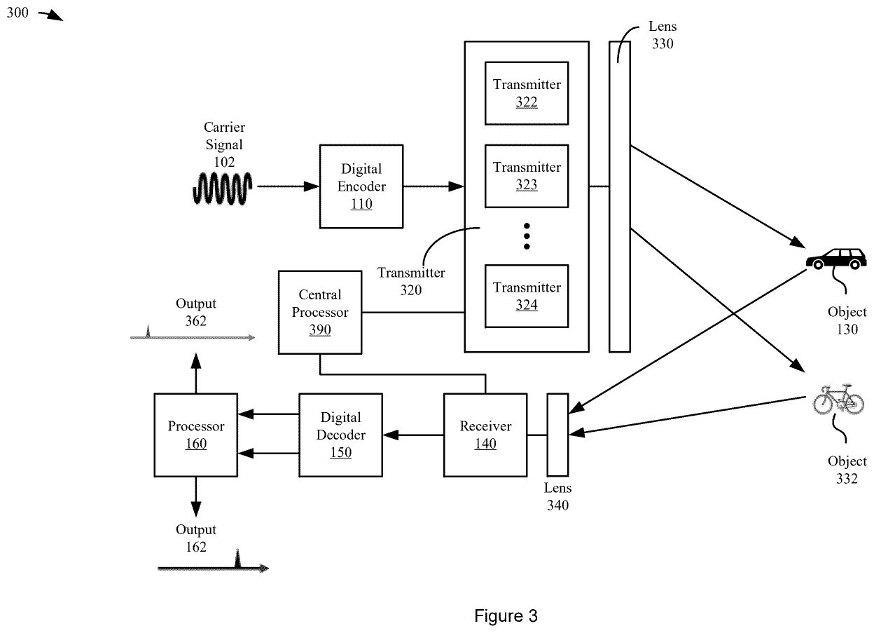

FIG. 3 depicts yet another example of a diagram of a hardware-based system 300 for deriving spatial information according to one aspect of the present embodiments. System 300 includes a carrier 102 and a digital encoder 110 on the transmitter side similar to FIG. 1, above. In one nonlimiting example, the transmitter 320 is configured to transmit the signal out and may include multiple transmitters 322, 323, . . . , 324. In other words, an array of signals may be transmitted to improve the accuracy. In one nonlimiting example, the digital encoder 110 may send one unique code to one transmitter, e.g., transmitter 322, and another unique code to another transmitter, e.g., transmitter 324, in order to distinguish between the two transmitted signals and to distinguish between the echoed signal when each of the transmitted signals are echoed back and received by a receiver. In one nonlimiting example, the transmitter 320 may be coupled to a lens 330. The lens 330 is configured to increase sensitivity, improve sensor accuracy, implement beamforming, and increase the refresh rate. It is appreciated that the angular resolution is dependent on the dimensions for the lens 330.

The transmitted signal may interact with objects 130 and 332, e.g., reflect, echo, etc. The echoed signal is received by the lens 340 on the receiver side. The lens 340 operates substantially similar to that on the transmitter side. The received signal is processed by the receiver 140 and sent to the digital decoder 150 that may be a 1-dimensional (1D) or 2-dimensional (2D) array. Since two different echoed signals are received and a 1D or 2D array is used for the digital decoder 150, the processor 160 may distinguish between the signal coming from objects 130 and 332. The processor 160 may output the spatial information associated with the objects 130 and 332 as output signals 162 and 362 respectively.

It is appreciated that a central processor 390 may be coupled to the transmitter 320 and/or the receiver 140. According to one nonlimiting example, the central processor 390 is configured to control the operation, e.g., synchronization, optimization, etc., of the transmitter 320 and/or the operation, e.g., synchronization, optimization, etc., of the receiver 140. It is appreciated that one central processor 390 coupled to the transmitter 320 and the receiver 140 is shown for illustrative purposes and should not be construed as limiting the scope of the embodiments. For example, two central processors may be used, where one is coupled to the transmitter 320 and the other is coupled to the receiver 140.

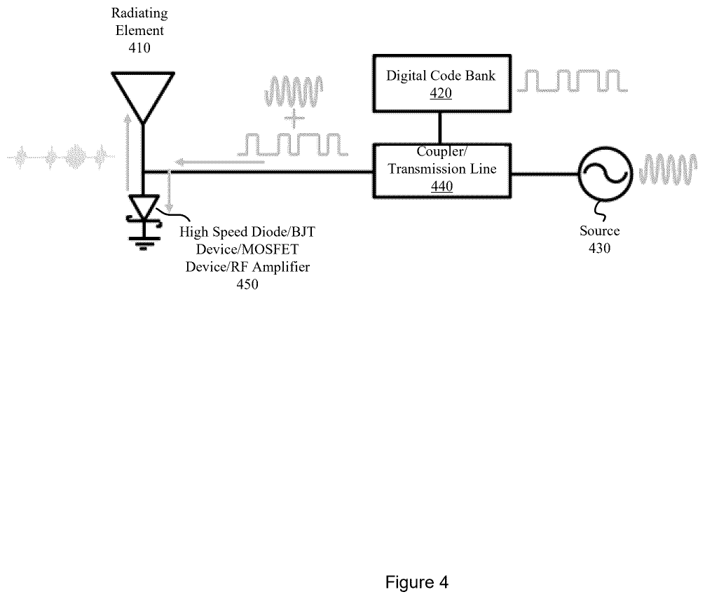

FIG. 4 depicts an example of a diagram of a transmitter according to one aspect of the present embodiments. The transmitter may include a source 430, a digital code bank 420, a coupler/transmission line 440, an RF amplifier, a high-speed diode/Bipolar Junction Transistor (BJT) device/MOSFET/RF amplifier device 450, and a radiating element 410. The source 430 generates the carrier signal at or near THz and may include an oscillator, a phase lock loop (PLL), a wide band comb generator (e.g., PIN diode, step recovery diode, etc.). It is appreciated that the source 430 may be built for each transmitter or may be shared among multiple transmitters.

The digital code bank 420 may store a plurality of digital codes, e.g., deterministic, random, pseudorandom, etc. The digital codes may be preloaded or may be adjusted or even computed in the field. According to some embodiments, each transmitter may have its own unique digital code. In one nonlimiting example, a synchronization signal may be sent from the digital code bank 420 to the receiver to determine the time of flight (ToF). The digital code that is modulated with the signal from the source 430 is transmitted by the coupler/transmission line 440 to a nonlinear device, e.g., high speed diode/BJT device/MOSFET device 450. It is appreciated that the nonlinear device may be one device attached to the radiating element 410 (antenna) or multiple devices attached to multiple locations of the radiating element 410 (antenna). The radiating element 410 may include a micro lens, e.g., smooth, Fresnel, etc., to improve the energy coupling. The radiating element 410 may be an on-chip antenna or package antenna (built in glass, ceramic substrate, high speed printed circuit board (PCB), etc.).

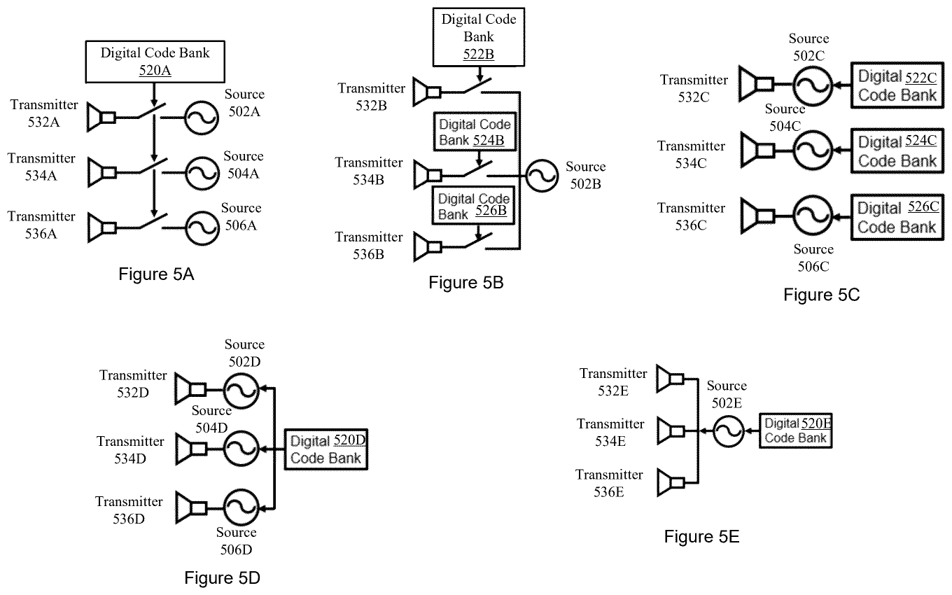

FIGS. 5A-5E depict a system for performing digital encoding according to one aspect of the present embodiments. FIG. 5A illustrates a single digital code bank 520A (e.g., single digital code is used for encoding) used with three sources 502A-506A (identical or different carrier signal/modulating signal) and three transmitters 532A-536A to generate three identical or different output signals. In comparison in FIG. 5B, one source 502B is used and three digital code banks 522B-526B (three identical or different digital codes) to encode the source signal in order to generate three identical or different signals that may be transmitted out from the three transmitters 532B-536B. In yet another example, in FIG. 5C, three digital code banks 522C-526C is used with three source 502C-506C signals to generate three output signals transmitted via three transmitters 532C-536C. As yet another example, in FIG. 5D, one digital code bank 520D is used with three different sources 502D-506D to generate three identical or different output signals transmitted via transmitters 532D-536D. In FIG. 5E, a single digital code bank 520E is used with a single source 502E and three transmitters 532E-536E to generate an array of output signal (to increase output power). In one nonlimiting example, the digital code bank 520E is configured to control the source 502E by controlling the power supply, triggering oscillation, etc. The three sources depicted in the figure serve solely for the purpose of concept illustration and not intended to limit the scope of the embodiments.

In one embodiment, the system includes a central processor configured to control the modulation of the digital code for each transmitter, as well as the amplitude and phase of each transmitter. The central processor may dynamically adjust the modulation parameters of the digital code in response to real-time feedback from the transmitters, thereby ensuring optimal performance under varying conditions. To achieve this, the central processor may utilize an adaptive algorithm that optimizes the amplitude and phase settings of each transmitter, enhancing signal clarity and strength. The central processor is communicatively connected to each transmitter via a high-speed data link, allowing for rapid and precise control over modulation and transmission parameters. This configuration ensures that the central processor can synchronize the transmission signals from multiple transmitters, achieving a coherent combined signal output. Additionally, the central processor includes a memory that stores predefined modulation schemes and amplitude/phase adjustment protocols tailored for various operational scenarios, providing a versatile and adaptable system. Furthermore, the central processor is capable of performing real-time diagnostics and fault detection on each transmitter. The central processor can adjust the modulation, amplitude, and phase settings accordingly to maintain optimal performance, even in the event of a transmitter malfunction or suboptimal conditions. To enhance system reliability, the central processor may integrate machine learning algorithms that predict and adjust for environmental changes affecting signal transmission, thereby ensuring consistent and reliable operation of the system.

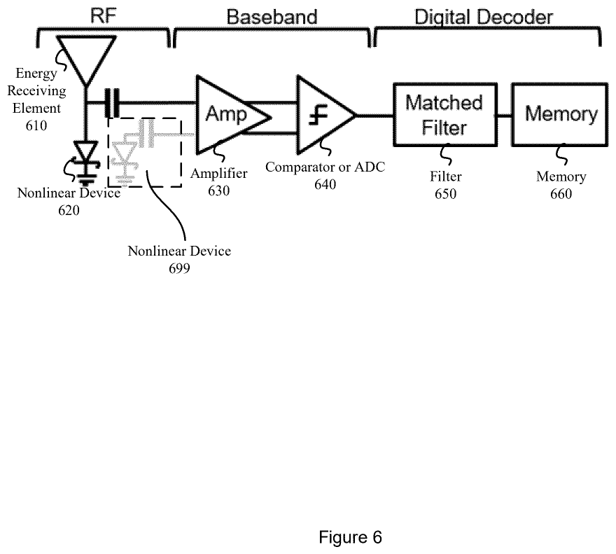

FIG. 6 depicts an example of a diagram of a receiver according to one aspect of the present embodiments. The receiver includes an RF section, a baseband section, and a digital decoder section. The RF section may include energy-receiving element 610 and a nonlinear device 620, e.g., Schottky diode that has a higher cut-off frequency in comparison to MOS devices. The baseband section may include an amplifier 630 and a one-bit comparator or multiple bit analog to digital converter (ADC) 640. The digital decoder section may include a filter 650 and a memory 660.

It is appreciated that the receiver may be flip-chip bonded to the antenna package and may also include a micro lens to improve energy coupling. The radiating element 610 may be an on-chip antenna or a package antenna (similar to that discussed in FIG. 4). The nonlinear device 620 may be a high-speed diode, a BJT, a MOSFET device, etc., and may be one device attached to the radiating element 610 or may be multiple devices that are attached to multiple locations of the radiating element 610.

The baseband section may be associated with each receiver or may be shared between multiple receivers. It is appreciated that the baseband bandwidth may be tunable from 10s of Hz to 10s of GHz. The amplifier 630 may amplify the signal and optionally be coupled to a nonlinear device 699. The comparator or ADC 640 may be triggered a number of times for each code in order to improve the timing and ranging accuracy. In one nonlimiting example, the baseband may include a pseudo-differential baseband and may improve power supply rejection ratio (PSRR) and reduce interference.

The digital decoder may be associated with each receiver or may be shared with multiple receivers. The digital decoder primarily consists of a code domain filter and a memory bank. The code domain filter compares the echo signal with the original transmitter code to reject interference and calculates the Time of Flight (ToF) of the echo signal, which provides the target's range information. The measured range information is stored in the memory bank, which accumulates the ranging results over time to improve measurement accuracy. The filter 650 may be a 255-bit XNOR based match filter used for ToF extraction. In some embodiments, the result of the extraction may be stored in accumulator, e.g., memory 660, and read out after each frame. In one nonlimiting example, threshold control can be applied at both the filter output and the memory output to adjust false alarm rates and reduce the readout data rate.

In one nonlimiting example, the digital decoder may not only perform code matching to associate the data with a particular transmitted signal that is echoed back to derive ToF, but may perform additional processing among frames to improve the SNR or to extract the target from the background among multiple receivers.

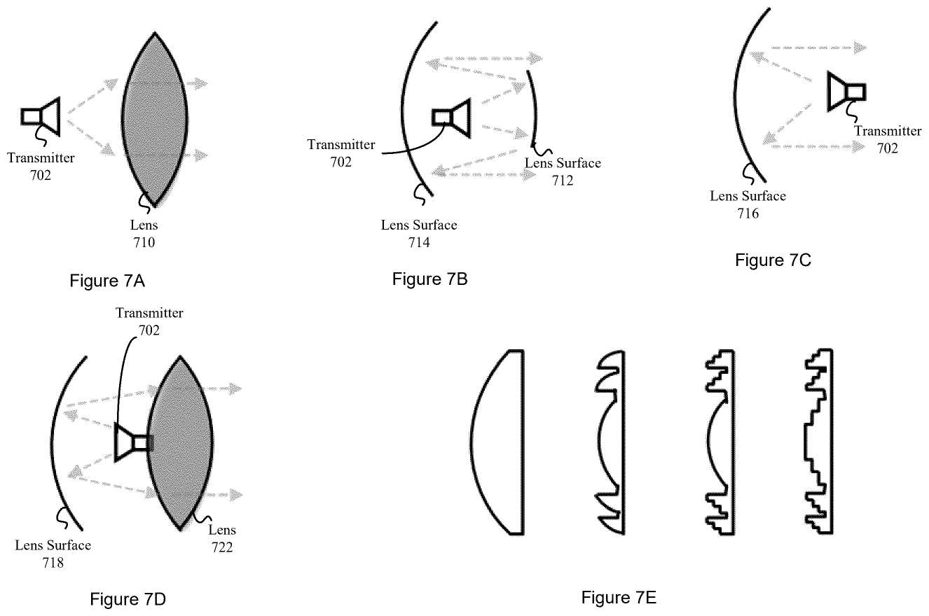

FIGS. 7A-7E depict examples of one or multiple lenses used on a transmitter and/or receiver according to one aspect of the present embodiments. In FIG. 7A, a lens 710 (dual surface) is shown with a transmitter 702. The transmitter may transmit two signals in different directions to the lens 710. The lens 710 may change the angle of the transmitted signals and output the two signals. It is appreciated that FIG. 7A shows a transmitter 702 for illustrative purposes and should not be construed as limiting the scope of the embodiments. For example, the lens 710 may be used with a receiver. Referring now to FIG. 7B, the lens may include two lens surfaces 712 and 714. The transmitter 702 may be positioned between the two surfaces 712 and 714. The signal output from the transmitter 702 may be reflected from the lens surface 712 to the lens surface 714. The lens surface 714 then reflects the signal out. It is appreciated that FIG. 7B shows a transmitter 702 for illustrative purposes and should not be construed as limiting the scope of the embodiments. For example, the lens surfaces 712 and 714 may be used with a receiver. In FIG. 7C, a single lens surface 716 is shown where the transmitter 702 outputs two signals that are reflected back from the lens surface 716. It is appreciated that FIG. 7C shows a transmitter for illustrative purposes and should not be construed as limiting the scope of the embodiments. For example, the lens surface 716 may be used with a receiver. In FIG. 7D, a lens 722 is used in conjunction with lens surface 718 and the transmitter 702 is positioned in between the two. The transmitter 702 may output two signals that are reflected from the lens surface 718 toward the lens 722. The lens 722 changes the angle of transmission and outputs the signals. It is appreciated that FIG. 7D shows a transmitter for illustrative purposes and should not be construed as limiting the scope of the embodiments. For example, the lens surface 718 and lens 722 may be used with a receiver. FIG. 7E, shows nonlimiting examples of the shape for the lens.

As illustrated, a single or dual surface lens or any combination thereof may be used by the transmitter and/or receiver. The lens may be smoothed or engraved or may include a combination of both. It is appreciated that the depth associated with engraving may be associated with selective frequencies. In one nonlimiting example, coating may be applied to the surface of the lens to enhance durability, improve transparency, and reduce scattering.

It is appreciated that the lens dimensions may be selected based on a desired target angular resolution and beamforming gain. The lens may be manufactured from plastic, silicon, ceramic, metal, polyethylene (PE), polypropylene (PP), polymethyl methacrylate (PMMA), etc. Moreover, the lens may be installed on the transmitter, the receiver, or any combination thereof. Furthermore, depending on the application, a single lens or multiple lenses may be used and may be designed with a fixed format or tunable format (e.g., meta surface, adjustable relative positions among lenses, etc.).

According to some embodiments, the transmitter and the receiver may be built in one chip. According to one nonlimiting example, the transmitter and the receiver may share the same lens. Also according to one nonlimiting example, the transmitter and the receiver may share the same antenna. It is appreciated that multiple transmitter and multiple receivers may be used to improve spatial coverage and resolution. The transmitter and/or the receiver may be mounted in a scanning or operational platform. In some embodiments, the system may include one or multiple transmitters and one or multiple receivers, at or around THz for generating the carrier signal.

In one nonlimiting example, the system (as described above) may include a code-modulated mm-wave (a pattern generator that generates an envelop signal that is modulated by a modulator with the carrier signal) transmitter, a plastic Fresnel lens (or other types of lens for beam shaping and/or frequency selection), and an imaging receiver array. The operating frequency may be around 220 GHz, providing an appropriate trade-off among wavelength, aperture size, cost, and attenuation in free space. According to one nonlimiting example a coded on/off keying (OOK) is selected because of ease of implementation to extract ToF in digital domain and clock access, reduced power consumption, and orthogonal coding to reduce interference.

As described above, during each measurement instance (subframe), the transmitter is configured to send a coded pulse waveform. The reflections from the targets are focused by the lens onto the imaging array, where the pulses are detected continuously. As each pixel (unit receiver) receives reflected signals within a narrow solid angle defined by the lens, the target's angular information is extracted using knowledge of the pixel location in the image plane. Finally, in-pixel matched filters identify the reflection and estimate range associated with the target using a ToF delay correlation.

Each receiver may include one or multiple lenses for beam shaping and frequency selection, a CMOS imaging array in which each pixel includes one or more energy coupling devices such as micro lens and antenna, a detector device to detect the received signal, and post processing circuitries to signal amplification and envelop pattern recognition. The embodiments, as described, are configured to detect the presence of a target and their location by analyzing the timing of reflections in the ToF data. Additionally, the embodiments distinguish and filter out nearby interfaces by identifying their distinctive patterns within the received signal.

A practical application of the system, as described above, is described in Exhibit A, entitled “Near-THz CMOS Camera For Automotive Applications” and is incorporated herein by reference in its entirety.

In at least some of the embodiments, the structures and/or functions of any of the above-described interfaces and panels can be implemented in software, hardware, firmware, circuitry, or a combination thereof. Note that the structures and constituent elements shown throughout, as well as their functionality, can be aggregated with one or more other structures or elements.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the embodiments and their practical applications, thereby enabling others skilled in the relevant art to understand the claimed subject matter, the various embodiments and the various modifications that are suited to the particular use contemplated.

What is claimed is:

1. A system comprising:
a transmitter that includes:
a digital encoder configured to receive a carrier signal between 100 GHz and 3 THz, wherein the digital encoder is further configured to receive a digital code and to modulate the digital code with the carrier signal to form an encoded digital signal; and
a transmitting antenna configured to receive the encoded digital signal and transmit the encoded digital signal out; and
a receiver that includes:
a receiving antenna configured to receive an echoed signal in response to the encoded digital signal interacting with an object;
a digital decoder configured to decode the echoed signal based on the digital code to form a decoded echoed signal; and
a processor configured to receive the decoded echoed signal and further configured to process the decoded echoed signal to determine spatial information with respect to the object.

2. The system of claim 1, wherein the spatial information includes at least one or more of a position of the object, an angular information associated with the object, a speed or velocity of the object, an acceleration of the object, and a distance associated with the object.

3. The system of claim 1 further comprising one micro lens coupled to the receiving antenna.

4. The system of claim 1 further comprising one or multiple lenses coupled to the receiving antenna.

5. The system of claim 1 further comprising a micro lens that is coupled to the transmitting antenna.

6. The system of claim 1 further comprising one or multiple lenses coupled to the transmitting antenna.

7. The system of claim 1, wherein the digital encoder is configured to encode the carrier signal with multiple digital codes, and wherein each encoded signal is used to distinguish between different objects.

8. The system of claim 1, wherein the spatial information is extracted in digital domain.

9. A system comprising:
a plurality of transmitters, each transmitter of the plurality of transmitters comprising:
a digital encoder configured to receive a carrier signal between 100 GHz and 3 THz at around a THz range, wherein the digital encoder is further configured to receive a digital code and to modulate the digital code with the carrier signal to form an encoded digital signal; and
a transmitting antenna configured to receive the encoded digital signal and transmit the encoded digital signal out; and
a receiver that includes:
a receiving antenna configured to receive an echoed signal in response to the encoded digital signal interacting with an object;
a digital decoder configured to decode the echoed signal based on the digital code to form a decoded echoed signal; and
a processor configured to receive the decoded echoed signal and further configured to process the decoded echoed signal to determine spatial information with respect to the object.

10. The system of claim 9, wherein the spatial information includes at least one or more of a position of the object, an angular information associated with the object, a speed or velocity of the object, an acceleration of the object, and a distance associated with the object.

11. The system of claim 9 further comprises a micro lenses coupled to the receiving antenna.

12. The system of claim 9 further comprises one or multiple lenses coupled to the receiving antenna.

13. The system of claim 9 further comprises a micro lenses coupled to the transmitting antenna.

14. The system of claim 9 further comprises one or multiple lenses coupled to the transmitting antenna in each transmitter.

15. The system of claim 9, wherein the digital encoder is configured to encode the carrier signal with multiple digital codes, and wherein each encoded signal is used to distinguish between different objects.

16. The system of claim 9, wherein the spatial information is extracted in digital domain.

17. The system of claim 9, wherein the processor is further configured to dynamically adjust the modulation parameters of the digital code in response to real-time feedback from the plurality of transmitters.

18. The system of claim 9, wherein the processor utilizes an adaptive algorithm to optimize the amplitude and phase settings of each transmitter for enhanced signal clarity and strength.

19. The system of claim 9, wherein the processor is programmed to synchronize transmission of signals generated by each transmitter of the plurality of transmitters to achieve a coherent combined signal output.

20. The system of claim 9, wherein the processor includes a memory storing predefined modulation schemes and amplitude/phase adjustment protocols for various operational scenarios.

21. The system of claim 9, wherein the processor integrates machine learning algorithms to predict and adjust for environmental changes affecting signal transmission.
